(19) United States
(12) Patent Application Publication
(10) Pub. No.: US 2019/0009410 A1
(43) Pub. Date: Jan. 10, 2019

(54) Determining An Orientation Of A Robot Relative To The Direction Of Gravity

(71) Applicant: KUKA Deutschland GmbH, Augsburg (DE)

(72) Inventor: Helmuth Radrich, Augsburg (DE)

(73) Assignee: KUKA Deutschland GmbH, Augsburg (DE)

(21) Appl. No.: 16/068,239

(22) PCT Filed: Jan. 9, 2017
(86) PCT No.: PCT/EP2017/000022

§ 371 Date: Jul. 5, 2018

(30) Foreign Application Priority Data
Jan. 11, 2016 (DE) 10 2016 000 187.9

(51) Int. Cl. B25J 9/16

(52) U.S. Cl. CPC B25J 9/1664; B25J 9/1694

(57) ABSTRACT

A method for determining an orientation or installation of a robot relative to a direction of gravity for at least one installation location of the robot, and for horizontal alignment or alignment relative to the direction of gravity of a robot includes creating a model wherein joint forces are identified in at least one calibration pose. The robot is then into a new installation location and the joint forces of the robot are identified in at least one measuring pose. Based on the identified joint forces and the model of the robot, the orientation, i.e. the orientation or the installation, of the robot relative to the direction of gravity is determined. The orientation of the robot is corrected by tilting the robot base such that the identified joint forces do not deviate from the forces defined in the model.

### CROSS-REFERENCE

This application is a national phase application under 35 U.S.C. § 371 of International Patent Application No. PCT/EP2017/000022, filed Jan. 9, 2017 (pending), which claims the benefit of German Patent Application No. DE 10 2016 000 187.9 filed Jan. 11, 2016, the disclosures of which are incorporated by reference herein in their entirety.

### TECHNICAL FIELD

The present invention relates to a method for determining an orientation of a robot relative to a gravitational direction, and to a controller and a computer program for performing a method.

### BACKGROUND

Kinetic models of robots, of the kind used particularly in model-based railway planning, regulation, and the like, take into account particularly the influence of weight forces of the robot, in particular a robot-guided tool and a robot-guided useful load as applicable.

The correspondence of such models to reality, and thus also the quality of the uses based on them, thus depend particularly on the precision with which the actual current gravitational direction is taken into account in the model: if the real robot is installed tilted relative to an alignment assumed in the model, or if a gravitational direction on which the model is based deviates from the actual current gravitational direction, the result as a rule is deviations in variables, in particular forces, that have been ascertained based on that model.

To enhance the quality of such a model and of a use based on it, an absolute alignment of the robot—or an alignment or the robot that is as horizontal or vertical as possible relative to the environment—can therefore be advantageous.

If a model of a tool-carrying robot, in particular parameters such as mass, center of gravity, and/or inertia sensor of a tool guided by the robot, is calibrated by means of the robot, then the orientation of the robot relative to the gravitational direction when this calibrated model is used should be as close as possible to the orientation when it was calibrated, since otherwise deviations in the orientations lead to deviations in variables ascertained based on the calibrated model, and in particular also to resulting process parameters of applications. This is because deviations between the actual gravitational direction and the gravitational direction on which the model is based in the calibration are intrinsically compensated for when applications of the robot are parametrized, so that even at different installation locations, the same orientation should once again be present, in order to equilibrate this intrinsic compensation.

Accordingly, in addition to or alternatively to an alignment of the robot that is as horizontal or vertical as absolutely possible, it can be advantageous to restore the orientation that was present when calibrating a model of the tool-carrying robot, or the orientation on which the model is based.

EP 0 522 411 A1 has disclosed a method for calibrating a robot in which spirit levels are positioned on limbs of the robot arm and the joints are calibrated so that the limbs enclose a predetermined angle with the gravitational direction.

### SUMMARY

The object of the present invention is to improve the operation of a robot.

This object is attained by a method as disclosed herein.

In one embodiment of the present invention, a method for determining an orientation of a robot, in particular a robot base, relative to the gravitational direction, in particular to an actual current gravitational direction or to a gravitational direction that is fundamental to a model, in particular calibrated at a different installation location, or that was present upon calibration of the model relative to the robot, at an installation location or a plurality of installation locations of the robot (one for each installation location) has the steps of:

detecting joint forces of the robot in one or more measuring poses at the (respective) installation locations of the robot; and

ascertaining an orientation, in particular an actual current orientation, of the robot, in particular of the robot base, relative to this gravitational direction (at the respective installation location) based on the detected joint forces and based on a model of the robot.

Thus in one embodiment, the robot itself, or its detected joint forces, are used so to speak as an electronic spirit level, in particular as an “absolute” spirit level for determining an actual current gravitational direction, or as a “relative” spirit level for restoring an orientation that was previously present, particularly upon calibration, relative to the actual gravitational direction at that time.

In one embodiment, the robot has a robot arm with a (proximal robot) base and a (distal tool) flange, which are movably connected to each other by means of one or more joints, and in particular at least six and in particular at least seven joints, in particular swivel and/or sliding joints. In one embodiment, the robot (arm) has drive means, in particular electrical drives, for moving one or more of the joints.

The expression “orientation relative to a gravitational direction” is understood here particularly as the (one- or two-dimensional angular) location of the robot, in particular its base and/or a robot-specific, in particular robot (arm)-base-specific reference system, in particular an axis (of motion) of the robot and/or a (reference) axis or (reference) plane of the reference system, relative to this gravitational direction.

This orientation can be ascertained or defined in particular as a deviation between this gravitational direction and the (motion or reference) axis of the robot and/or reference system, and in another embodiment as this gravitational direction in a robot-specific, in particular robot (arm)-base-specific, reference system.

The joint forces are detected in one embodiment by means of force sensors on and particularly in the joints, in particular drive means, and/or detected outputs. In general, joint forces are understood in particular to mean forces, in particular driving and/or supporting forces, which robot limbs, connected to one another in articulated fashion, exert on one another, particularly in the direction of or around the axis of motion, or in the degree of freedom of the respective joint.

For the sake of a more concise representation, antiparallel force couples or torques are generally called forces here; thus joint forces can in particular also be joint (rotational) moments, in particular around rotational axes of the joints, and in particular, analogously to force sensors, they can also be torque sensors. Accordingly, a joint force can in particular be a torque around a rotational axis which two limbs of the robot, connected rotatably to each other around this rotational axis, mutually exert on each other.

In one embodiment, the joint forces are detected without extreme forces from the environment acting on the robot, or without the robot—except for a securing face—being in contact with the surroundings. Accordingly, the model in one embodiment is a model of the (externally) load-free or contactless robot.

The (mathematical or mechanical) model of the robot, in one embodiment, maps coordinates q of the robot, which depend on its pose and in particular indicate or determine it, onto one another, in particular joint coordinates or positional and/or orientation coordinates of a robot-specific reference, in particular the TCP, and forces T, in particular joint forces, weight forces, and inertial, centrifugal, frictional and/or external forces.

One such model is accordingly called a kinetic model here. In one embodiment, along with static forces such as weight forces, the model also includes dynamic forces such as inertial and/or centrifugal forces, in particular and/or time derivations of the coordinates, in particular speeds, accelerations, and/or higher derivations. Such a model is accordingly called a dynamic model here.

In one embodiment, the model can be indicated generally in the usual form in the field

M(q,g_{model})\ddot{q}+h(q,\dot{q},g_{model})=T_{model} (1)

indicating the mass matrix M(q,g_{model}), the speeds or accelerations \dot{q}, \ddot{q}, the generalized forces h(q, \dot{q}, g_{model}), (the vector) of the gravitational (force or direction) g_{model}, and model forces, in particular model joint forces T_{model}. In a static kinetic model, the terms \dot{q}, \ddot{q} can be omitted or can be equal to zero.

If the model joint forces T_{model} ascertained based on the model are compared with the detected actual joint forces Tₘₑₐₛ, the results of these comparisons are deviations, especially in the otherwise correct and in particular appropriately calibrated model, or if other model accuracies or errors are ignored, at least essentially only because of the deviation between the gravitational direction or gravitational vector g_{model} that is fundamental to the model and the actual current gravitational direction or gravitational vector g_{actual}. It should be noted that the gravitational direction g_{model} on which the model is based relative to the robot can be used in corresponding kinetic parameters of the model, such as masses, locations of center of gravity, and/or inertia sensors.

Accordingly, based on this deviation between the detected joint forces Tₘₑₐₛ and the model joint forces T_{model} ascertained based on the model of the robot, which is typically used to determine external forces (Tₑₓₜₑᵣₙ=Tₘₑₐₛ−T_{model}), the deviation between the gravitational direction g_{model} on which the model is based and the actual current gravitational direction g_{actual} and thus the orientation of the robot relative to a gravitational direction can be detected:

$$Δ g = {g}_{ist} - {g}_{Modell} = Ψ ( {τ}_{mess} - \underbrace{M ( q , {g}_{Modell} ) \ddot{q} + h ( q , \dot{q} , {g}_{Modell} )}_{{τ}_{Modell}} ) . \qquad ( 2 )$$

Here, ψ designates a function which maps the external forces onto the orientation or a corresponding correction variable. For instance, it can have the unitary or (inverse or possibly pseudo-) Jacoby matrix, in particular.

In one embodiment, if the gravitational direction g_{model} on which the model is based is specified or known in a robot-specific, in particular robot (arm)-base-specific, reference system, then the orientation of this reference system, particularly relative to the actual current gravitational direction g_{actual}, can be correspondingly ascertained based on equation (2) or (by minimizing the deviation), this reference system can be aligned horizontally or vertically, either absolutely or relative to the surroundings.

In the same way, by making the detected (orientation relative to the) actual current gravitational direction g_{actual} (again) approximate the orientation or gravitational direction g_{model} fundamental to the model, this orientation relative to the actual gravitational direction that was present when it was calibrated can in particular be (re-) established. In this case, the orientation of the robot is ascertained relative to the gravitational direction (relative to the robot) on which the model is based (when its calibration is performed).

As can be seen from equation (2), the orientation of the robot relative to the gravitational direction can, in one embodiment, be ascertained particularly in the form of a deviation dg between the, in particular actual current, gravitational direction g_{actual} and a gravitational direction g_{model} on which the model is based and/or a robot-specific in particular robot (arm)-base-specific axis of motion.

In the same way, as can likewise be seen from equation (2), the orientation of the robot relative to the, in particular actual current, gravitational direction g_{actual} can be ascertained in one embodiment particularly in the form of this gravitational direction itself in a robot-specific, in particular robot (arm)-base-specific, reference system:

$$( {g}_{ist} = \underbrace{Ψ ( {τ}_{mess} - \underbrace{M ( q , {g}_{Modell} ) \ddot{q} + h ( q , \dot{q} , {g}_{Modell} )}_{{τ}_{Modell}} ) + {g}_{Modell}}_{{Ψ}^{′}} ) . \qquad ( 3 )$$

The orientation can in particular be ascertained or output in the form of one or two angles around one or two specified, in particular robot-specific, in particular robot (arm)-base-specific, axes, in particular correction axes—explained below—between the gravitational direction and the gravitational direction g_{model} fundamental to the model, or robot ((arm) base)-specific axis of motion. Likewise, it can be ascertained or output for instance component-wise, particularly in a robot ((arm) base)-specific reference system.

In one embodiment, the orientation relative to an actual or the actual current gravitational direction or to a gravitational direction (relative to the robot) fundamental to the model, in particular the calibrated model, or one that was present during the calibration, in particular its magnitude and/or direction, is ascertained and output, in particular displayed.

By ascertaining the orientation relative to the actual current gravitational direction, the robot can be used, so to speak, as an “absolute” spirit level and/or aligned horizontally or vertically, either absolutely or relative to the surroundings

By ascertaining the orientation relative to the gravitational direction fundamental to the model, which in one embodiment can in particular be the gravitational direction relative to the robot, in particular to a robot-specific and in particular robot (arm)-base-specific reference system (in particular of the model), that was present when the robot was calibrated, the robot can be used as a kind of “relative” spirit level, in order to restore the orientation fundamental to the model or gravitational direction relative to the robot.

In a further embodiment, the orientation can be output in the form of a one- or multi-dimensional correction variable around one or two, in particular robot-specific and/or specified, in particular structurally specified, correction axes, around which the robot—in particular its base—is, in a further embodiment, to be tilted or inclined, and in particular is supported in tiltable or inclinable fashion, in particular by adjusting one or more supports, explained below. It is thus advantageously possible to facilitate an alignment of the robot.

In a simple embodiment, for example for one or two correction axes (respectively), it is possible to display the (rotational) direction and/or the (rotational) angle into which direction or angle the robot is to be tilted in order to minimize a deviation between an actual current gravitational direction and a gravitational direction fundamental to the mode.

In general, in one embodiment, the orientation of the robot is ascertained and output in the form of a or the one- or multi-dimensional correction variable, in particular by displaying it, or a or the one- or multi-dimensional correction variable is ascertained and output, in particular by displaying it, which depends in particular monotonically and in particular linearly on the deviation between the ascertained joint forces and model joint forces ascertained based on the model of the robot, in particular decreases with the reduction of the deviation or increases with increasing deviation. In a further embodiment, the correction variable depends on the direction in which and/or the amount by which the robot is to be tilted in order to reduce the deviation, in particular maximally; in particular, it can indicate this direction or amount.

For example, in one embodiment, the rotational direction in which and/or the amount by which the robot is to be tilted in order to reduce the deviation, in particular maximally, between the detected joint forces and the model joint forces ascertained based on the model of the robot can be displayed. Equally, in one embodiment, the direction in which the robot is to be tilted in order to reduce the deviation, in particular maximally, can be displayed, for instance as a directional arrow or angle. Additionally or alternatively in one embodiment, for instance as a magnitude of the directional arrow, it can be displayed how much the robot is to be tilted in that direction in order to reduce the deviation, in particular maximally.

In one embodiment, the orientation, in particular the correction variable, is ascertained and/or output cyclically or at periodic intervals.

As explained above, the deviation between the actual current gravitational direction and the gravitational direction fundamental to the model creates a deviation between the detected joint forces and model joint forces ascertained based on the model of the robot, so that a reduction in this deviation between the joint forces leads to an increasing approximation between the actual current gravitational direction and the gravitational direction fundamental to the model.

In one embodiment, a deviation or the deviation between the ascertained orientation and an or the orientation, fundamental to the model, of the robot relative to the gravitational direction, in particular a or the deviation between the ascertained actual gravitational direction and a or the gravitational direction fundamental to the model relative to the robot, and/or a or the correction variable, increasing in particular linearly, in particular with increasing deviation, as a result of tilting the robot, that is dependent on the deviation between the detected joint forces and the model joint forces ascertained based on the model of the robot, is reduced and in particular minimized by tilting the robot, in particular the tilting of its robot (arm) base and/or platform, around one, two, or more correction axes that are in particular perpendicular to one another and/or in particular structurally specified. In a further embodiment, for this purpose, the corresponding deviation or correction variable, in particular its direction and/or magnitude, is output, in particular displayed, in particular on the robot (arm) base or platform, in particular around one or more correction axes, in the form of a direction and/or an amount or the like.

As a result, in one embodiment, the alignment of the robot can be corrected. This can equally be done at least partly manually and/or at least partly in automated fashion, in particular by altering one or more supports of the robot, in particular its robot base or a platform of the mobile robot.

In one embodiment, in one or (each of) a plurality of measuring poses, one or more axes of motion of the robot form an angle, which amounts at most to 30° and in particular at most 10°, with a robot-specific correction axis specified, in particular structurally, around which an alignment of the robot is correctable, in particular by altering one or more supports of the robot, in particular its robot base or platform. In other words, in one embodiment, in at least one measuring pose, at least one axis of motion of the robot is, at least essentially, parallel to a correction axis.

In a further embodiment, in one or (each of) a plurality of these measuring poses, one or more further axes of motion of the robot form an angle, which likewise amounts at most to 30° and in particular at most 10°, with a further, in particular structurally, specified robot-specific correction axis around which the alignment of the robot is correctable, in particular by altering one or more supports of the robot, in particular its robot base or platform. In other words, in the further embodiment, in at least one of the measuring poses, at least one further axis of motion of the robot is also, at least essentially, parallel to a further correction axis.

As a result, in one embodiment, corrections of the alignment of the robot in the robot-specific correction axes each advantageously have a direct effect on the axes of motion or joints of the robot that are at least essentially parallel to them.

In one embodiment, in at least one measuring pose, a horizontal spacing between a or the distal flange and a or the base of the robot amounts to at least 50%, and in particular at least 75%, of a maximum horizontal spacing between the flange and the base.

By means of such an at least essentially horizontal pose, weight forces advantageously have an especially strong effect, which can improve the precision of the ascertained orientation to the gravitational direction.

In one embodiment, in one or more installation locations in one or more measuring poses, joint forces of the toolless robot are respectively detected, and the orientation of the robot relative to the gravitational direction is ascertained based on these detected joint forces and a model of the toolless robot, and in a further embodiment the ascertained orientation is output and/or the deviation between the ascertained orientation and an orientation on which the model is based, respectively, is reduced by tilting the robot around at least one correction axis.

Models of the toolless robot can advantageously be more precise. In one embodiment this makes it possible in particular to use the robot or its (tool less) model as an “absolute” spirit level and thus to align it precisely.

If the robot, in particular at its (distal) flange, has a tool, in particular connected separably to the flange, then this can be taken into account in a model of the tool-carrying robot. If the robot with its tool, in particular grippers, has a useful load, then that useful load can analogously be taken into account in a model of the useful load-carrying robot.

In a further embodiment, such a model can be calibrated in at least one installation location in one or more calibration poses, in particular by ascertaining, in a manner that is known per se, the parameters of the tool or model of the tool-carrying robot or the useful load or the model of the useful load-carrying robot from the deviations between ascertained joint forces and a model of the tool-carrying or useful load-carrying robot.

Accordingly, in one embodiment, in addition or alternatively, in one or more further installation locations in one or more measuring poses, joint forces of the tool-carrying and in particular useful load-carrying robot are ascertained, and the orientation of the robot to the gravitational direction is ascertained based on these ascertained joint forces and a model of the tool-carrying and in particular useful load-carrying robot, and in a further embodiment, the orientation ascertained in each case is output and/or the deviation between the ascertained orientation and an orientation fundamental to the model is reduced by tilting the robot around at least one correction axis.

As explained at the beginning, by a calibration of a model of the tool-carrying, in particular useful load-carrying robot in an installation location, an alignment or gravitational direction, which possibly deviates from an actual alignment or gravitational direction and is based on the model, is intrinsically equally compensated for in the calibration poses. In particular, in order to also embody robot applications that were parametrized based on this (intrinsically compensated-for) model correctly in a new installation location, in one embodiment in at least one installation location, parameters of the model of the tool-carrying, in particular useful load-carrying robot are calibrated in one or more calibration poses, and in at least one further installation location, the orientation of the robot relative to the gravitational direction is ascertained, and in a further embodiment, the ascertained orientation in each case is output and/or the deviation between the ascertained orientation and an orientation fundamental to the calibrated model is reduced by tilting the robot around at least one correction axis.

As a result, the orientation of the robot relative to the actual current gravitational direction in its new or further installation locations can correspond at least essentially to the orientation in the installation location with which or in which the model had been calibrated. Thus a robot application parametrized based on this model can be carried out better in the new or further installation location.

In a further embodiment, at least one of the measuring poses in one of the new or further installation locations deviates—by at most 10% and in particular at most 1% of a maximum range of motion of the robot—from a calibration pose in which parameters of the model of the tool-carrying, in particular useful load-carrying robot were previously calculated. The maximum range of motion and accordingly the deviation or percentages stated can in particular refer to Cartesian or axial or joint coordinates. For instance, in one embodiment two measuring poses, which differ from one another in each joint coordinate by at most 10% of a maximum range of values of this joint coordinate, deviate from one another by at most 10% of a maximum range of motion of the robot. In the same way, in one embodiment, two measuring poses, which in each TCP coordinate differ from one another by at most 10% of a maximum range of values of that coordinate, differ from one another by at most 10% of a maximum range of motion of the robot. As a result, in one embodiment, the precision can be increased still further.

In one embodiment of the present invention, a method for determining an orientation of a robot relative to a gravitational direction in at least one installation location of the robot has the steps of:

detecting a weight force in at least one measuring pose of the robot by means of a force sensor positioned on the robot, in particular a or the (proximal robot) base or a or the (distal tool) flange of the robot; and

ascertaining an orientation of the robot, in particular of a robot-specific system, relative to the gravitational direction based on the weight force detected and a known orientation of the force sensor relative to the robot.

Thus in one embodiment, it is not the robot itself but rather a force sensor positioned on it that is used as an electronic spirit level, so to speak, in particular as an “absolute” or “relative” spirit level: a weight force determined by a force sensor depends in particular on the orientation of the force sensor relative to the actual current gravitational direction or gravitational vector g_{actual}. If the orientation of the force sensor relative to the robot, in particular a robot-specific reference system, is known, in particular specified and/or measured, it is thus possible based on a weight force determined by means of the force sensor and based on the known orientation of the force sensor relative to the robot or reference system to also ascertain the orientation of the robot, in particular the robot-specific reference system, relative to the actual current gravitational direction or gravitational vector.

In one embodiment, the force sensor is secured to the robot and/or to a robot-specific force sensor mount in such a way that it can be detached without being destroyed, in particular by means of a screw connection, plug-in connection, clamp connection and/or detent connection. As a result it can advantageously be removed if not needed, and an interruption of robot operation can thus be avoided. In another embodiment, the force sensor is secured to the robot in a way that is detachable without being destroyed, particularly in a firmly bonded manner. As a result, its location relative to the robot can advantageously be fixed.

In one embodiment, the force sensor detects a robot-guided useful load, or is arranged for that purpose, in particular being positioned on the flange or the base of the robot. In another embodiment, the force sensor detects a weight force of the useful load-carrying or useful load-free robot, or is arranged for that, in particular being positioned on the base of the robot.

In one embodiment, by means of the multi-axial force sensor, components of the weight force in multiple directions are detected, and in a further embodiment the orientation of the force sensor or of the robot on which the force sensor is positioned is ascertained from this relative to the actual current gravitational direction or gravitational vector.

In another embodiment, by means of the monoaxial force sensor, only one component of the weight force is detected in the axial direction, and in a further embodiment, based on this force, the orientation of this axial or detection direction of the force sensor, or the orientation of the robot on which the force sensor is positioned, is ascertained relative to a gravitational direction or gravitational vector, in particular an actual current gravitational direction or a gravitational direction fundamental to a calibration, in particular of a or the model.

In one embodiment, a correction variable, which depends on and in particular indicates a current orientation of the robot ascertained based on the detected weight force relative to the actual gravitational direction or a deviation between this actual orientation and an orientation of the robot relative to the actual gravitational direction that was present during a calibration of the robot, is ascertained and displayed. As a result, an orientation of the robot that was present upon a calibration of the robot can be (re-)established in particular by tilting the robot in such a way that this deviation is reduced and in particular minimized.

In one embodiment, the robot is a mobile or transportable robot.

Particularly in mobile robots which in one embodiment are installed selectively and/or successively at different installation locations, an ascertainment and optionally output and/or correction, described here, of an orientation is advantageous.

In a further embodiment, the mobile robot has a movable, in particular drivable, platform, on which in a further embodiment its robot base is positioned, particularly in such a way that it can be detached either non-destructively or destructively. In one embodiment, the platform can be movable on rails or can be freely movable and to that end in a further embodiment it can have one or more air cushions, one or more non-driven, and/or one or more driven wheels, rollers, or the like.

In one embodiment, the robot, in particular its (arm) base and/or its platform, has one or more supports of variable length and/or position, by which its alignment relative to a surface of the robot for it to stand on or be secured to, in particular its base and/or its platform, is variable, in particular structurally, and in particular is adjustable or settable. By means of the adjustable supports, in one embodiment, one or more robot-specific correction axes are structurally specified.

In a simple embodiment, at least one support can be moved inward or outward and/or is pivotable, in particular manually or mechanically, in particular by means of a screw thread or by pneumatic and/or hydraulic means.

In one embodiment, a controller for controlling a or the robot, in particular using hardware and/or software and particularly program technology, for performing a method described here is arranged or has the following:

means for detecting joint forces of the robot, in particular a toolless and/or tool-carrying, in particular useful load-carrying robot, in at least one measuring pose; and

means for ascertaining an orientation of the robot relative to the gravitational direction based on the detected joint forces and a model of the robot, in particular a toolless and/or tool-carrying, in particular useful load-carrying robot.

In one embodiment the controller has:

means for ascertaining the orientation based on a deviation between the detected joint forces and model joint forces ascertained based on the model of the robot; and/or

means for ascertaining and outputting, in particular displaying, the orientation relative to an actual current gravitational direction or to a gravitational direction fundamental to the model, in particular a correction variable dependent on the deviation between the detected joint forces and model joint forces ascertained based on the model of the robot; and/or

means for reducing a deviation between the ascertained orientation and an orientation fundamental to the model, in particular a correction variable dependent on the deviation between the detected joint forces and model joint forces ascertained based on the model of the robot, by tilting the robot around at least one correction axis; and/or

means for calibrating parameters of the model of the tool-carrying, in particular useful load-carrying robot in at least one calibration pose in at least one installation location, and means for ascertaining the orientation of the robot relative to the gravitational direction fundamental to the calibration of the model, in at least one further installation location.

In one embodiment, the controller has the following:

means for detecting a weight force in at least one measuring pose of the robot by means of a force sensor positioned on the robot, in particular on a or the (proximal robot) base or a or the (distal tool) flange of the robot; and

means for ascertaining an orientation of the robot, in particular a robot-specific reference system, relative to the gravitational direction based on the detected weight force and a known orientation of the force sensor relative to the robot.

Accordingly, in one embodiment a force sensor is positioned on the robot, in particular a or the (proximal robot) base or a or the (distal tool) flange of the robot, and in a further embodiment is connected to the controller in signaling fashion.

In a further embodiment, the controller has means for ascertaining and displaying a correction variable that depends on and in particular indicates a current orientation of the robot relative to the actual gravitational direction, which orientation is ascertained based on the detected weight force, or relative to a deviation between this current orientation and an orientation of the robot relative to the actual gravitational direction that was present during a calibration of the robot.

A means in the sense of the present invention can be embodied as hardware and/or software, and in particular can have a processing unit, in particular a microprocessor unit (CPU), which in particular is digital and is preferably connected for data and signals to a memory system and/or bus system, and/or can have one or more programs or program modules. The CPU can be embodied for processing commands which are implemented as a program stored in a memory system for detecting input signals from a data bus and/or for outputting output signals to a data bus. A memory system can have one or more, in particular different kinds of, storage media, in particular optical, magnetic, solid-state and/or other nonvolatile media. The program may be of such a nature that it embodies the methods described here or is capable of performing them, so that the CPU can perform the steps of such methods and thus in particular can control the robot.

In this context, the expression “controlling the robot” is in particular also understood to mean regulating the robot.

In one embodiment, one or more steps of the method are performed entirely or partly in automated fashion.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the present invention.

FIG. 1 depicts a mobile robot with a controller in accordance with an embodiment of the present invention; and

FIG. 2 depicts a method in accordance with an embodiment of the present invention.

### DETAILED DESCRIPTION

The robot has a robot arm with a proximal robot base 11 and a distal tool flange 16, on which a tool 12 is positioned in such a way that it can be detached without being destroyed. The base 11 and flange 16 are movably connected to one another by means of seven actuated pivot joints, the joint angles of which are detected as q₁, . . . , q₇.

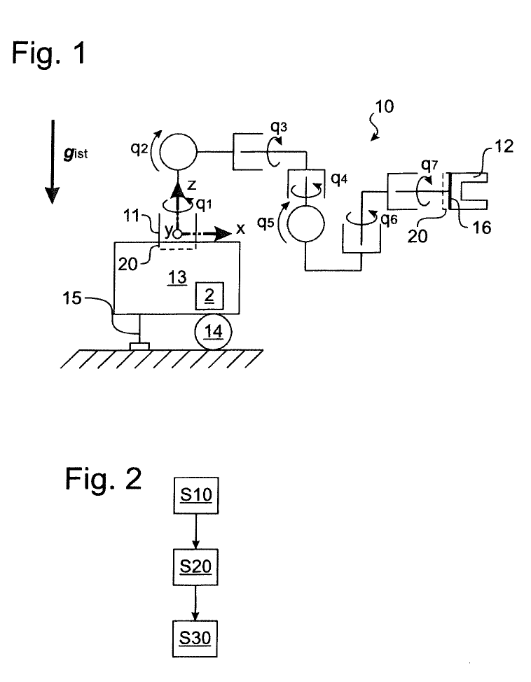

In FIG. 1, a robot-base-specific reference (coordinate) system (x, y, z), the z axis of which is aligned with the first axis of motion (see q₁) of the robot, and an actual current gravitational direction g_{actual}, are shown.

The mobile robot further has a drivable platform 13 with for example two wheels 14, on which its robot base 11 is positioned.

For example, the platform has two supports 15 of variable length, by means of which an alignment of the robot relative to the surface on which it stands can be varied. In the exemplary embodiment, the supports 15 can be pivoted in and out by means of a screw thread. By synchronously pivoting the two supports 15, positioned one after the other in the viewing direction of FIG. 1, in or out, the robot 10 or its platform 13 can be tilted around a structurally specified robot-specific correction axis that is parallel to the y axis. By asynchronously pivoting the two supports 15 in or out, the robot 10 or its platform 13 can be tilted around a further, structurally specified robot-specific correction axis that is parallel to the x axis.

The controller 2, in an at least partly automated manner, performs a method, explained hereinafter with reference to FIG. 2, in accordance with one embodiment of the present invention for determining an orientation of the robot 10 relative to a gravitational direction.

For what is seen in absolute terms as a horizontal or vertical alignment of the robot 10 in its current installation location, in a step S10 in the measuring pose shown in FIG. 1, the joint forces Tₘₑₐₛ acting in the joints are detected and the tool 12 is removed.

In a step S20, from the joint angles q₁, . . . , q₇, based on a model of the toolless robot, in accordance with equation (1), the controller 2 ascertains model joint forces T_{model} and, based on the deviation between the detected joint forces Tₘₑₐₛ and the model joint forces T_{model} that is ascertained based on that model, according to equation (2), it ascertains an orientation of the robot relative to the actual current gravitational direction g_{actual} or a correction variable dependent on the deviation between the detected joint forces Tₘₑₐₛ and model joint forces T_{model} ascertained based on the model of the robot.

This can be seen in FIG. 1: what is acting on the second joint (see q₂) is essentially the weight force of the robot limbs (on the right in FIG. 1) that are positioned distally from this joint. The joint momentum in the second joint thus depends on the weight of these limbs and on the horizontal lever arm of the weight force. If the orientation of the robot 10, or of its reference system (x, y, z), now deviates from the (ideal) orientation shown in FIG. 1, which is based on the model and in its first or z axis is antiparallel to the actual current gravitational direction g_{actual}, then the actual operative horizontal lever arm, and thus the joint momentum in the second joint, changes accordingly.

This joint momentum in the second joint then deviates from the joint momentum ascertained based on the model or of the gravitational direction g_{model}=[0,0,−g]^{T} fundamental to it. Accordingly, the controller 2—based on this deviation between the ascertained joint momentum and the model joint momentum ascertained based on the model of the robot—can conversely ascertain the orientation of the robot 10 or of its robot (base)-specific reference system (x, y, z) relative to the actual current gravitational direction g_{actual} in the (x-z) plane or a corresponding component of the correction variable.

Analogously, the controller can also ascertain the orientation in the (y-z) plane or a corresponding component of the correction variable, for instance based on the joint momentum in the third joint (see q₃).

By taking into account further joint momentums, such as the joint momentum in the fifth joint (see q₅) for the orientation in the (x-z) plane and/or the joint momentum in the seventh joint (see q₇) for the orientation in the (x-z) plane, and/or by repeating steps S10 and S20 for further measuring poses, rotated for instance by 90° around the first axis (see q₁), the ascertainment can be performed redundantly and thus its precision can be enhanced, in particular by means of averaging.

In step S30, the ascertained current orientation or correction variable of the robot 10 can be displayed, for instance in the form of angles around the x and y axes by which the robot-base-specific z axis, or the gravitational direction g_{model}=[0,0−g]^{T} which is fundamental to the model, and the actual current g_{actual} deviate from each other.

By adjusting the (lengths of the) supports 15, the user can correct the alignment of the robot 10, and in particular of its platform 13, so as to minimize the deviation between the ascertained orientation and the orientation or correction variable on which the model is based.

In this way, the robot 10 can be aligned absolutely horizontally or vertically.

In the same way, a previous orientation of the robot upon calibration of a model of the tool-carrying robot can be restored in another installation location:

To do so, first this model is calibrated in an installation location in a manner that is known per se by approaching various calibration poses and ascertaining the joint momentums in those poses. Parameters of the model can be calibrated based on the deviation of these ascertained joint momentums from joint momentums ascertained based on the model.

This too can be illustrated with FIG. 1: as stated above, the weight forces of the distal robot limbs act in the second joint. A difference between the ascertained joint momentum and the joint momentum that is ascertained based on the model of the tool-carrying robot with a tool mass and an initial center of gravity location makes it possible in a manner that is known per se, to ascertain the mass and center of gravity location in the (x-z) plane, in particular iteratively.

If the robot 10 is then installed in a further installation location, its orientation relative to the actual current gravitational direction there should once again be equivalent to the one that was also present in the calibration explained above. This is because deviations between the actual orientation and the orientation fundamental to the model upon calibration are intrinsically compensated for in the parametrization of robot applications based on the calibrated model. This compensation should accordingly also be taken into account (or be able to be taken into account) (again) in the new or further installation location as well.

Accordingly, in the further installation location, once again in steps S10-S30, the joint forces T_{meas operative} acting in the joints are ascertained (S10); now, as already in the calibration of the model of the tool-carrying robot, the tool 12 is secured to the robot flange 16; from the joint angles q₁, . . . , q₇, based on the model of the tool-carrying robot in accordance with equation (1), model joint forces T_{model} are ascertained (S20) and a multidimensional correction variable with components in the x and y directions is displayed, which correction variable depends, for instance linearly, on the deviation between the ascertained joint forces Tₘₑₐₛ and the model joint forces T_{model} (S30).

The correction variable can be displayed for example in the form of the rotational direction and/or angle around the x and y axes. Equally, it can be displayed for example in the form of a directional arrow in the x-y plane, into which plane the z axis is to be tilted; the size of the directional arrow can indicate the tilt angle. It can for instance also be displayed in the form of a correction axis in the x-y plane, around which the z axis is to be tilted; in a further embodiment, the direction of rotation and/or tilt angle can be displayed, for example also numerically.

Because by moving the supports 15 in or out, the user changes the alignment of the platform 13 so that the displayed correction variable is minimized, the user employs the same orientation, in the new or further installation position, that existed when the model of the tool-carrying robot was calibrated.

In this way, the calibrated model can also be used in the new or further installation position, and in particular without the robot, for calibration of the model, being aligned absolutely horizontally or vertically.

FIG. 1 shows an advantageous measuring pose: it is clear that the second and fifth axes of motion of the robot form an angle, which amounts to 0°, with the robot-specific correction axis y, by which the alignment of the robot is correctable by altering the supports 15 of the robot. As a result, corrections of the alignment of the robot around the y axes advantageously have a direct effect on the second and fifth axes of motion.

Analogously, the third and seventh axes of motion of the robot form an angle, which likewise amounts to 0°, with the further correction axis x, by which the alignment of the robot is correctable by altering one of the supports 15. As a result, corrections of the alignment of the robot around the x axes advantageously have a direct effect on the third and seventh axis of motion.

Furthermore, in the measuring pose, a horizontal spacing between the distal flange 16 and the base 11 of the robot amounts to 100% of a maximum horizontal spacing between the flange and the base, so that the weight forces have an especially strong effect.

In a modification, a force sensor in the form of a load cell 20, shown in dashed lines in FIG. 1, is positioned on the base 11 or the flange 16.

In this modification, the controller 2 in step S10, by means of the load cell 20 (positioned on the base), ascertains a weight force of the robot arm, optionally including the useful load, or, by means of the load cell 20 (positioned on the base or the flange), a weight force of a robot-guided useful load.

In one embodiment of this modification, the multiaxial load cell 20 in step S10 ascertains components mₓ, m_{y}, m_{z} of the weight force m in the three directions of the robot-base-specific reference coordinate system (x, y, z).

From this, the controller 2 in step S20 ascertains the orientation of the load cell 20, or of the robot on which the load cell is positioned in a known orientation, in particular the orientation of its robot-base-specific reference coordinate system, relative to the actual current gravitational direction that is determined by the direction of the vector [mₓ, m_{y}, m_{z}]^{T}. For instance, if the load cell 20 detects only a negative weight force (component) in its z axis direction, then this is oriented in the opposite direction from and parallel to the actual current gravitational direction.

In another embodiment of this modification, the monoaxial load cell 20 in step S10 detects only one component m_{z} of the weight force m in the axial or detection direction z of the robot-base-specific reference coordinate system (x, y, z).

Based on this, in step S20, the controller 2 ascertains the orientation of the load cell 20, or of the robot on which the load cell is positioned in a known orientation, relative to the actual current gravitational direction. If, for example, the amount |m| of the weight force m is known, then the orientation can be ascertained based the ratio m_{z}/|m|, which assumes the maximum value 1 if the detection direction z and the actual current gravitational direction coincide.

In step S30, the controller 2 ascertains a correction variable, which indicates the current orientation, ascertained based on the detected weight force, of the robot relative to the actual gravitational direction, and displays it, for example as the ratio m_{z}/|m|. The user can minimize this by tilting the platform 13 and thus the robot 10 and thus aligning the robot absolutely with the actual gravitational direction. This is also possible if the amount |m| of the weight force m is not known, since the component m_{z} has an extreme value if the z axis direction of the load cell, or of the robot-base-specific reference coordinate system, coincides with the actual current gravitational direction.

Likewise, the correction variable can also indicate the deviation between the ascertained current orientation and an orientation of the robot relative to the actual gravitational direction that was present during a calibration of the robot, such as the deviation between the components mₓ, m_{y}, m_{z} of the currently detected weight force and the corresponding components that were detected during a calibration of the robot. Because the user, by tilting the platform 13 and thus the robot 10, minimizes this (multidimensional) deviation, he restores the orientation that was present during the calibration of the robot, so that in particular, a robot model that is calibrated in the course of this is once again correct. Although exemplary embodiments were explained in the foregoing description, it should be noted that multiple modifications are possible. It is furthermore noted that the exemplary embodiments are solely examples, which are in no way intended to limit the scope of patent protection, the applications, and the structure thereof. On the contrary, from the description above, the person skilled in the art is provided with guidelines for implementing at least one exemplary embodiment; various changes, particularly in terms of the function and location of the components described, can be made without departing from the scope of protection as defined by the claims and the feature combinations equivalent to them.

1. A method for determining an orientation of a robot (10) relative to a gravitational direction (g_{actual}) in at least one installation location of the robot, having the steps of:
detecting (S10) joint forces of the robot in at least one measuring pose; and
ascertaining (S20) an orientation of the robot relative to the gravitational direction based on the detected joint forces and a model of the robot.

2-15. (canceled)
